(19) United States
(12) Patent Application Publication
(10) Pub. No.: US 2021/0159471 A1
(43) Pub. Date: May 27, 2021

(54) GASKET ADAPTER FOR BATTERY ASSEMBLY OF ELECTRIFIED VEHICLE

(71) Applicant: Ford Global Technologies, LLC, Dearborn, MI (US)

(72) Inventors: Samuel Jeffrey Tomlinson, Farmington Hills, MI (US); Justin Negrete, Plymouth, MI (US)

(21) Appl. No.: 16/690,351

(22) Filed: Nov. 21, 2019

(51) Int. Cl. H01M 2/08; H01M 2/10; H01M 2/02

(52) U.S. Cl. CPC H01M 2/08; H01M 2/024; H01M 2/1077

(57) ABSTRACT

This disclosure relates to a gasket adapter for use in a battery assembly of an electrified vehicle. An example battery assembly includes a gasket with a perimeter strand providing at least a portion of an outer perimeter pathway of the gasket, a secondary strand providing at least a portion of a secondary pathway of the gasket, and an adapter connected to the perimeter strand and the secondary strand.

### TECHNICAL FIELD

This disclosure relates to a gasket adapter for use in a battery assembly of an electrified vehicle.

### BACKGROUND

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by battery powered electric machines. Conventional motor vehicles, by contrast, rely exclusively on an internal combustion engine to propel the vehicle.

### SUMMARY

A battery assembly for an electrified vehicle according to an exemplary aspect of the present disclosure includes, among other things, a gasket including a perimeter strand providing at least a portion of an outer perimeter pathway of the gasket, a secondary strand providing at least a portion of a secondary pathway of the gasket, and an adapter connected to the perimeter strand and the secondary strand.

In a further non-limiting embodiment of the foregoing battery assembly, the adapter is a first adapter and the gasket further comprises a second adapter, and the secondary strand is connected to the first and second adapters.

In a further non-limiting embodiment of any of the foregoing battery assemblies, the first and second adapters are on opposite sides of the outer perimeter pathway.

In a further non-limiting embodiment of any of the foregoing battery assemblies, the perimeter strand is a first perimeter strand and the gasket further comprises a second perimeter strand.

In a further non-limiting embodiment of any of the foregoing battery assemblies, the first perimeter strand provides a first portion of the outer perimeter pathway and the second perimeter strand provides a second portion of the outer perimeter pathway.

In a further non-limiting embodiment of any of the foregoing battery assemblies, the first perimeter strand is longer than the second perimeter strand.

In a further non-limiting embodiment of any of the foregoing battery assemblies, the first perimeter strand is connected to a first side of a first section the first adapter and a first side of a first section of the second adapter, and the second perimeter strand is connected to a second side of the first section of the first adapter and a second side of the first section of the second adapter.

In a further non-limiting embodiment of any of the foregoing battery assemblies, the first adapter includes a second section, the second adapter includes a second section, and the secondary strand is connected to the second sections of the first and second adapter.

In a further non-limiting embodiment of any of the foregoing battery assemblies, the second sections of the first adapter and the second adapter extend from respective first sections in a direction substantially normal to the respective first section.

In a further non-limiting embodiment of any of the foregoing battery assemblies, the second sections of the first adapter and the second adapter lie in a common horizontal plane with the outer perimeter pathway.

In a further non-limiting embodiment of any of the foregoing battery assemblies, the second sections of the first adapter and the second adapter extend from respective first sections at a non-ninety degree angle relative to the respective first section.

In a further non-limiting embodiment of any of the foregoing battery assemblies, the second sections of the first adapter and the second adapter do not lie in a common horizontal plane with the outer perimeter pathway.

In a further non-limiting embodiment of any of the foregoing battery assemblies, the secondary pathway does not lie in a common horizontal plane with the outer perimeter pathway.

In a further non-limiting embodiment of any of the foregoing battery assemblies, the secondary pathway is vertically above the second portion of the outer perimeter pathway.

In a further non-limiting embodiment of any of the foregoing battery assemblies, the first portion of the outer perimeter pathway provides a seal between a first portion of an enclosure assembly and a second portion of the enclosure assembly, the second portion of the outer perimeter pathway provides a seal between a third portion of the enclosure assembly and the second portion of the enclosure assembly, the secondary pathway provides a seal between the third portion of the enclosure assembly and the first portion of the enclosure assembly, and the third portion of the enclosure assembly includes a coolant fluid inlet and coolant fluid outlet.

In a further non-limiting embodiment of any of the foregoing battery assemblies, the assembly includes an enclosure assembly surrounding an array of battery cells, and the gasket seals a space between mating surfaces of the enclosure assembly.

In a further non-limiting embodiment of any of the foregoing battery assemblies, the array of battery cells is a first array of battery cells and the battery assembly includes a second array of battery cells, and the first and second arrays of battery cells are within the outer perimeter pathway and are on opposite sides of the secondary pathway.

In a further non-limiting embodiment of any of the foregoing battery assemblies, the perimeter strand and the secondary strand are made of rubber and are vulcanized to the adapter.

A method according to an exemplary aspect of the present disclosure includes, among other things, extruding perimeter and secondary strands of a gasket for a battery assembly of an electrified vehicle, injection molding an adapter, vulcanizing the perimeter strand to the adapter, and vulcanizing the secondary strand to the adapter.

In a further non-limiting embodiment of the foregoing method, the perimeter strand provides at least a portion of an outer perimeter pathway of the gasket, and the secondary strand provides at least a portion of a secondary pathway of the gasket, and the secondary pathway either (1) lies in a common horizontal plane with the outer perimeter pathway or (2) does not lie in a common horizontal plane with the outer perimeter pathway and is arranged vertically above a portion of the outer perimeter pathway.

### BRIEF DESCRIPTION OF THE DRAWINGS

FIG. 1 schematically illustrates an example powertrain of an electrified vehicle.

FIG. 2 schematically illustrates an example battery assembly of the electrified vehicle.

FIG. 3 is a somewhat schematic, top view of an example gasket.

FIG. 4 is a side view of the gasket of FIG. 3.

FIG. 5 is a close-up view of an example gasket adapter.

FIG. 6 is a somewhat schematic, top view of another example gasket.

FIG. 7 is a side view of the gasket of FIG. 6 taken along line 7-7 from FIG. 6.

FIG. 8 is an example battery assembly including the gasket of FIG. 6.

### DETAILED DESCRIPTION

This disclosure relates to a gasket adapter for use in a battery assembly of an electrified vehicle. An example battery assembly includes a gasket with a perimeter strand providing at least a portion of an outer perimeter pathway of the gasket, a secondary strand providing at least a portion of a secondary pathway of the gasket, and an adapter connected to the perimeter strand and the secondary strand. Among other benefits, which will be appreciated from the below description, the disclosed gasket accommodates and seals various types of battery enclosures, which may have diverse seal profiles. The disclosed gasket is also relatively robust while also being relatively inexpensive and easy to manufacture.

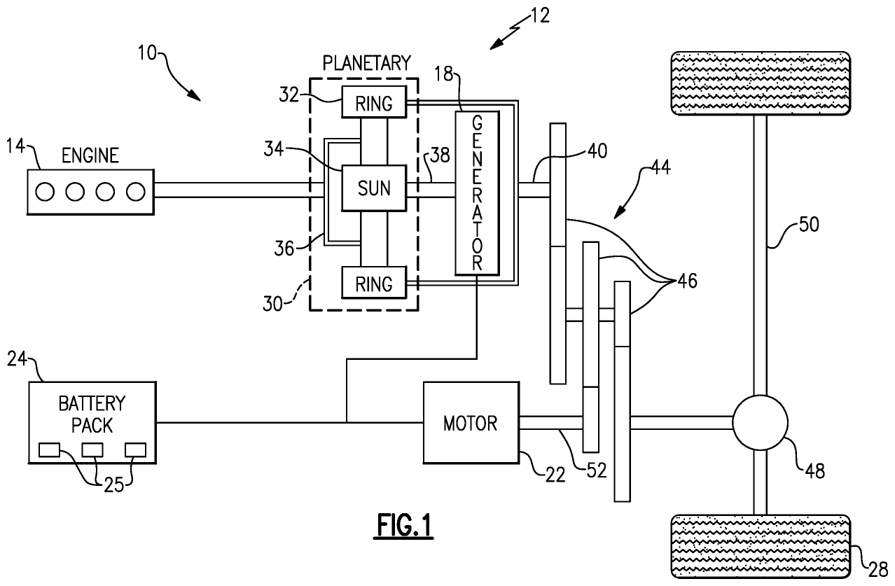

FIG. 1 schematically illustrates a powertrain 10 for an electrified vehicle 12. Although depicted as a hybrid electric vehicle (HEV), it should be understood that the concepts described herein are not limited to HEVs and could extend to other electrified vehicles, including, but not limited to, plug-in hybrid electric vehicles (PHEVs) and battery electric vehicles (BEVs).

In one embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery assembly 24. In this example, the second drive system is considered an electric drive system of the powertrain 10. The first and second drive systems generate torque to drive one or more sets of vehicle drive wheels 28 of the electrified vehicle 12. Although a power-split configuration is shown, this disclosure extends to any hybrid or electric vehicle including full hybrids, parallel hybrids, series hybrids, mild hybrids or micro hybrids.

The engine 14, which in one embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery assembly 24.

The battery assembly 24 is an exemplary electrified vehicle battery. The battery assembly 24 may be a high voltage traction battery pack that includes a plurality of battery assemblies 25 (i.e., battery arrays or groupings of battery cells) capable of outputting electrical power to operate the motor 22, the generator 18, and/or other electrical loads of the electrified vehicle 12. Other types of energy storage devices and/or output devices can also be used to electrically power the electrified vehicle 12.

In one non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery assembly 24 state of charge up to its maximum allowable discharging rate under certain driving patterns/cycles. The EV mode is an example of a charge depleting mode of operation for the electrified vehicle 12. During EV mode, the state of charge of the battery assembly 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery assembly 24 at a constant or approximately constant level by increasing the engine 14 propulsion usage. The electrified vehicle 12 may be operated in other operating modes in addition to the EV and HEV modes within the scope of this disclosure.

FIG. 2 illustrates additional detail of the battery assembly 24. The battery assembly 24 includes battery arrays, which can be described as groupings of battery cells, for supplying electrical power to various vehicle components. In this example there are two battery arrays 56A, 56B. Although two battery arrays 56A, 56B are illustrated in FIG. 2, the battery assembly 24 could include a single battery array or multiple battery arrays. In other words, this disclosure is not limited to the specific configuration shown in FIG. 2.

Each battery array 56A, 56B includes a plurality of battery cells 58 that may be stacked side-by-side along a span length (i.e., the largest dimension) of each battery array 56A, 56B. Although not shown in the schematic depiction of FIG. 2, the battery cells 58 are electrically connected to one another using busbar assemblies. In one embodiment, the battery cells 58 are prismatic, lithium-ion cells. However, battery cells having other geometries (cylindrical, pouch, etc.) and/or other chemistries (nickel-metal hydride, lead-acid, etc.) could alternatively be utilized within the scope of this disclosure.

An enclosure assembly 60 (shown in phantom in FIG. 2) surrounds the battery arrays 56A, 56B. In one non-limiting embodiment, the enclosure assembly 60 includes a tray 62 and a cover 64 which establish a plurality of walls 66 that surround the interior 68 (i.e., area inside the walls 66). The enclosure assembly 60 may take any size, shape or configuration, and is not limited to the specific configuration of FIG. 2. The enclosure assembly 60 defines an interior 68 for housing the battery arrays 56A, 56B and, potentially, any other components of the battery assembly 24.

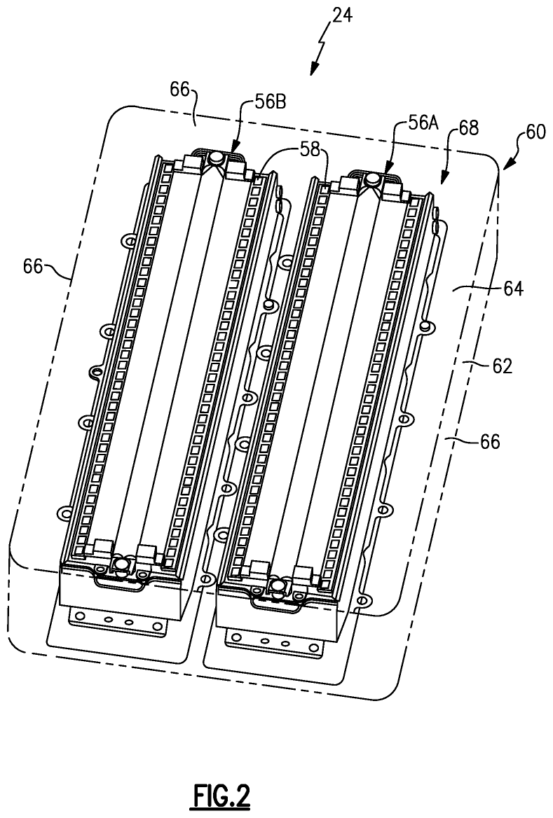

The enclosure assembly 60 may be made of one or more distinct parts, such as the tray 62 and the cover 64, which are connected together. In order to provide an air and water-tight seal, a gasket may fill the space between the mating surfaces of the parts of the enclosure assembly 60. An example gasket 70 is shown in FIG. 3 from a top view and FIG. 4 from a side view.

The gasket 70 includes two sealing pathways, which are paths along which the gasket 70 functions as a seal. A first sealing pathway is an outer perimeter pathway 72. The outer perimeter pathway 72 is generally rectangular and extends about and defines an outermost perimeter of the gasket 70. The outer perimeter pathway 72 in this example has a length dimension L₁, a width dimension W, and a height dimension H (FIG. 4). The height dimension H is less than the length and width dimensions L₁, W, and, to this end, the gasket 70 in this example is substantially flat.

The gasket 70 also functions as a seal along a secondary pathway 74, which is connected to the outer perimeter pathway 72 via one or more adapters, which may be referred to as gasket adapters. The term “secondary” is not intended to refer to relative significance of the sealing pathway, but rather to indicate that the secondary pathway 74 is another sealing pathway in addition to the outer perimeter pathway 72.

In the example of FIG. 3, the gasket 70 includes a first adapter 76 and a second adapter 78 connecting the outer perimeter pathway 72 to the secondary pathway 74. The first and second adapters 76, 78 are on opposite sides of the outer perimeter pathway 72 and are spaced apart by the secondary pathway 74 in this example.

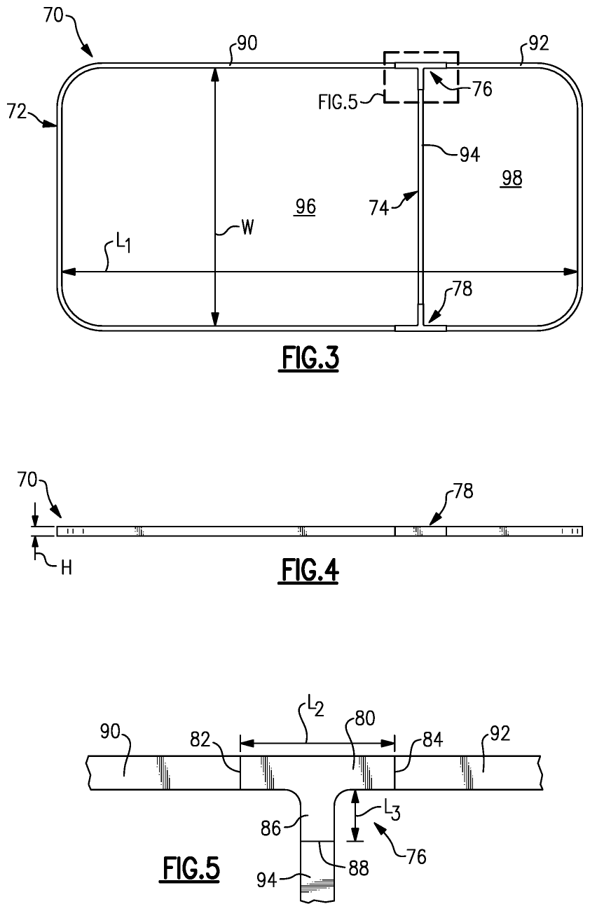

With reference to FIG. 5, the first adapter 76 includes a first section 80 extending between first and second sides 82, 84 along a length L₂ and a second section 86 projecting from the first section 80 toward the center of the gasket 70 along a length L₃, which is substantially normal to the length L₂. The second section 86 terminates at a face 88. The second adapter 78 is arranged substantially similar to the first adapter 76. The first and second adapters 76, 78 exhibit the height H.

The outer perimeter pathway 72 of the gasket 70 includes, in this example, a first outer perimeter strand 90 providing connected to a first side 82 of the first section 80 of the first adapter 76 and similarly to a first side of a first section of the second adapter 78. The outer perimeter pathway 72 further includes a second outer perimeter strand 92 connected to the second side 84 of the first section 80 of the first adapter 76 and similarly to a second side of a first section of the second adapter 76. The first and second outer perimeter strands 90, 92 are of different lengths in this example. In particular, the first outer perimeter strand 90 is longer than the second outer perimeter strand 92. The first section 80 of the first adapter 76 also provides a portion of the outer perimeter pathway 72, as does the corresponding first section of the second adapter 78. To this end, the first and second adapters 76, 78 are made of a material that is capable of providing an air and water-tight seal, such as rubber.

The secondary pathway 74 is provided by a secondary strand 94 connected to the face 88 of the second section 86 and a corresponding face of a second section of the second adapter 78. The secondary pathway 74 also includes the second section 86 of the first adapter 76 and a corresponding second section of the second adapter 78. The secondary strand 94 extends in a direction parallel to the width dimension W in this example. Further, the secondary strand 94, and in turn the secondary pathway 74 lies in a common horizontal plane (i.e., containing the length dimension L₁ and width dimension W) with the outer perimeter pathway 72. As shown in FIG. 4, the gasket 70 is substantially flat and lies in a common horizontal plane bounded by the height H. The secondary strand 94 may have a different sealing profile than the strands 90, 92. In an example, the secondary strand 94 may include two ridges and be configured to fit within a two-groove track of an enclosure assembly, whereas the strands 90, 92 may have a single ridge configured to fit within a single-groove track.

The strands 90, 92, 94 are formed of extruded rubber in one example. The first and second adapters 76, 78 are made of rubber and are formed by an injection molding process, in one example. The first and second adapters 76, 78 are substantially more rigid than the strands 90, 92, 94 in one example. The strands 90, 92, 94 are connected to the first and second adapters 76, 78 by vulcanizing.

In FIG. 3, a first space 96 is bound by the first outer perimeter strand 90 and the secondary strand 94, and a second space 98 is bound by the second outer perimeter strand 92 and the secondary strand 94. Different battery arrays may be arranged on opposite sides of the secondary strand 94, for example, and thus the gasket 70 may be used to fluidly isolate different battery arrays.

FIGS. 6 and 7 illustrate another example gasket 70′ which is similar to the gasket 70′ except that the secondary pathway 74′ does lie in a common horizontal plane with the outer perimeter pathway 72′. In FIGS. 6-7, the gasket 70′ includes like reference numerals to the example of FIGS. 3-5 with a trailing apostrophe. The gasket 70′ is similar to the gasket 70 unless otherwise described.

In the example of FIGS. 6 and 7, the secondary pathway 74′ is vertically spaced-apart relative to the outer perimeter pathway 72′. In particular, in FIGS. 6-7, the first adapter 76′ includes a first section 80′ arranged substantially similar to the first section 80 of FIGS. 3-5, but the second section 86′ projects vertically upward from the first section 80 at a non-zero and non-perpendicular angle A, in this example. The second adapter 78′ is arranged similarly. The secondary strand 94′ is connected to the second sections of the first and second adapters 76′, 78′ and as such is vertically above a portion of the outer perimeter pathway, namely the second outer perimeter strand 92′. The secondary strand 94′ follows the angle A adjacent the first and second adapters 76′, 78′ and otherwise extends parallel to the second outer perimeter strand 92′.

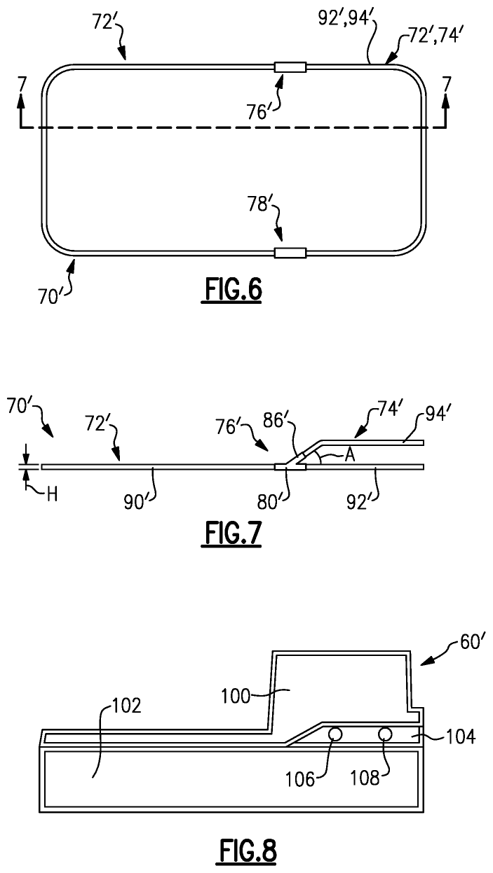

The gasket 70′ may be particularly useful in an enclosure assembly 60′ such that of FIG. 8. In FIG. 8, the enclosure assembly 60′ includes a first portion 100, a second portion 102, and third portion 104. The third portion 104 is vertically between the first and second portions 100, 102. The third portion 104 includes a fluid inlet 106 and a fluid outlet 108 in this example. The first, second, and third portions 100, 102, 104 are walls in one example.

The gasket 70′ is arranged relative to the enclosure assembly 60′ such that the first outer perimeter strand 90′ is arranged between and provides a seal between the first portion 100 and the second portion 102, and the second outer perimeter strand 92′ provides a seal between the third portion 104 and the second portion 102. Further, the secondary strand 94′ provides a seal between the third portion 104 of the enclosure assembly and the first portion 100.

It should be understood that terms such as “about,” “substantially,” and “generally” are not intended to be boundaryless terms, and should be interpreted consistent with the way one skilled in the art would interpret those terms. It should also be understood that directional terms such as “vertical,” “forward,” “rear,” “side,” etc., are used herein relative to the normal operational attitude of a vehicle for purposes of explanation only, and should not be deemed limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery assembly for an electrified vehicle, comprising:
a gasket including a perimeter strand providing at least a portion of an outer perimeter pathway of the gasket, a secondary strand providing at least a portion of a secondary pathway of the gasket, and an adapter connected to the perimeter strand and the secondary strand.

2. The battery assembly as recited in claim 1, wherein:
the adapter is a first adapter and the gasket further comprises a second adapter, and
the secondary strand is connected to the first and second adapters.

3. The battery assembly as recited in claim 2, wherein the first and second adapters are on opposite sides of the outer perimeter pathway.

4. The battery assembly as recited in claim 2, wherein the perimeter strand is a first perimeter strand and the gasket further comprises a second perimeter strand.

5. The battery assembly as recited in claim 4, wherein the first perimeter strand provides a first portion of the outer perimeter pathway and the second perimeter strand provides a second portion of the outer perimeter pathway.

6. The battery assembly as recited in claim 5, wherein the first perimeter strand is longer than the second perimeter strand.

7. The battery assembly as recited in claim 5, wherein:
the first perimeter strand is connected to a first side of a first section the first adapter and a first side of a first section of the second adapter, and
the second perimeter strand is connected to a second side of the first section of the first adapter and a second side of the first section of the second adapter.

8. The battery assembly as recited in claim 7, wherein:
the first adapter includes a second section,
the second adapter includes a second section, and
the secondary strand is connected to the second sections of the first and second adapter.

9. The battery assembly as recited in claim 8, wherein the second sections of the first adapter and the second adapter extend from respective first sections in a direction substantially normal to the respective first section.

10. The battery assembly as recited in claim 9, wherein the second sections of the first adapter and the second adapter lie in a common horizontal plane with the outer perimeter pathway.

11. The battery assembly as recited in claim 8, wherein the second sections of the first adapter and the second adapter extend from respective first sections at a non-ninety degree angle relative to the respective first section.

12. The battery assembly as recited in claim 11, wherein the second sections of the first adapter and the second adapter do not lie in a common horizontal plane with the outer perimeter pathway.

13. The battery assembly as recited in claim 11, wherein the secondary pathway does not lie in a common horizontal plane with the outer perimeter pathway.

14. The battery assembly as recited in claim 13, wherein the secondary pathway is vertically above the second portion of the outer perimeter pathway.

15. The battery assembly as recited in claim 14, wherein:
the first portion of the outer perimeter pathway provides a seal between a first portion of an enclosure assembly and a second portion of the enclosure assembly,
the second portion of the outer perimeter pathway provides a seal between a third portion of the enclosure assembly and the second portion of the enclosure assembly,
the secondary pathway provides a seal between the third portion of the enclosure assembly and the first portion of the enclosure assembly, and
the third portion of the enclosure assembly includes a coolant fluid inlet and coolant fluid outlet.

16. The battery assembly as recited in claim 1, further comprising an enclosure assembly surrounding an array of battery cells, wherein the gasket seals a space between mating surfaces of the enclosure assembly.

17. The battery assembly as recited in claim 16, wherein:
the array of battery cells is a first array of battery cells and the battery assembly includes a second array of battery cells, and
the first and second arrays of battery cells are within the outer perimeter pathway and are on opposite sides of the secondary pathway.

18. The battery assembly as recited in claim 1, wherein the perimeter strand and the secondary strand are made of rubber and are vulcanized to the adapter.

19. A method, comprising:
extruding perimeter and secondary strands of a gasket for a battery assembly of an electrified vehicle;
injection molding an adapter;
vulcanizing the perimeter strand to the adapter; and
vulcanizing the secondary strand to the adapter.

20. The method as recited in claim 19, wherein:
the perimeter strand provides at least a portion of an outer perimeter pathway of the gasket, and the secondary strand provides at least a portion of a secondary pathway of the gasket, and
the secondary pathway either (1) lies in a common horizontal plane with the outer perimeter pathway or (2) does not lie in a common horizontal plane with the outer perimeter pathway and is arranged vertically above a portion of the outer perimeter pathway.
